(19) United States
(12) Patent Application Publication
(10) Pub. No.: US 2012/0253974 A1
(43) Pub. Date: Oct. 4, 2012

(54) METHOD AND APPARATUS FOR PROVIDING MEMORY TAG-BASED PAYMENT METHODS

(75) Inventors: Mikko Sakari Haikonen, Espoo (FI); jan-Erik Ekberg, Vantaa (FI); Pekka Pasi Matias Honkonen, Kirkkonummi (FI); Jari-Jukka Harald Kaaja, Jarvenpaa (FI)

(73) Assignee: Nokia Corporation, Espoo (FI)

(21) Appl. No.: 13/099,649

(22) Filed: May 3, 2011

Related U.S. Application Data
(60) Provisional application No. 61/469,302, filed on Mar. 30, 2011.

(51) Int. Cl. G06Q 30/00; G06Q 20/00

(52) U.S. Cl. 705/26.41; 705/42

(57) ABSTRACT

An approach is provided for memory tag-based payment methods. A transaction management platform receives a payment request via a radio frequency memory tag associated with a device. The transaction management platform also processes and/or facilitates a processing of the payment request to determine whether the radio frequency memory tag includes a value that is sufficient to complete the payment request. On a determination that the value is not sufficient, the transaction management platform further causes, at least in part, one or more actions that result in the device initiating a transfer of additional value to the radio frequency memory tag to complete the payment request.

### RELATED APPLICATIONS

This application claims the benefit of the earlier filing date under 35 U.S.C. §119(e) of U.S. Provisional Application Ser. No. 61/469,302 filed on Mar. 30, 2011, entitled “Method and Apparatus for Providing Memory Tag-Based Payment Methods,” the entirety of which is incorporated herein by reference.

### BACKGROUND

Service providers (e.g., wireless, cellular, etc.) and device manufacturers are continually challenged to deliver value and convenience to consumers by, for example, providing compelling network services. One area of interest is providing the capability of automated purchase of goods, services, etc. to the users via Point of Sale (POS) locations such as, for example, vending machines, pillars, kiosks, smart posters, billboards, etc., wherein payment of the fees associated with purchased services can be performed by the user using mobile devices (e.g. micropayment).

On the other hand the development of low-cost radio frequency (RF) memory tags (e.g., high memory capacity near field communication (NFC) tags or other wireless memory tags) facilitates payments, and in return, delivery of services and access or transfer of related digital content provided by services (e.g., media files, documents, applications, etc.). For example, a payment process can be performed using mobile devices via online accounts, credit cards, etc. through various methods provided as online services (e.g., PayPal®, Amazon®, etc.) which require network connection. However, in today's emerging markets existence of such networks in every location is not obvious.

Additionally, in order for user authentication, sensitive information such as credit card numbers, passwords, user identification information, etc. may need to be transferred between the mobile devices, servers and the POS devices within the path of a user payment flow. This transfer of sensitive information can increase the vulnerability of the information and the risk of information falling into unauthorized hands.

### SOME EXAMPLE EMBODIMENTS

Therefore, there is a need for an approach for providing memory tag-based payment methods that reduce the need for network connection and information transfer over the network and as a result increase the availability of services in various locations and at the same time prevent unnecessary transfer of information over networks.

According to one embodiment, a method comprises receiving a payment request via a radio frequency memory tag associated with a device. The method also comprises processing and/or facilitating a processing of the payment request to determine whether the radio frequency memory tag includes a value that is sufficient to complete the payment request. The method further comprises, on a determination that the value is not sufficient, causing, at least in part, one or more actions that result in the device initiating a transfer of additional value to the radio frequency memory tag to complete the payment request.

According to another embodiment, an apparatus comprises at least one processor, and at least one memory including computer program code, the at least one memory and the computer program code configured to, with the at least one processor, cause, at least in part, the apparatus to receive a payment request via a radio frequency memory tag associated with a device. The apparatus is also caused to process and/or facilitate a processing of the payment request to determine whether the radio frequency memory tag includes a value that is sufficient to complete the payment request. The apparatus is further caused to, on a determination that the value is not sufficient, cause, at least in part, one or more actions that result in the device initiating a transfer of additional value to the radio frequency memory tag to complete the payment request.

According to another embodiment, a computer-readable storage medium carries one or more sequences of one or more instructions which, when executed by one or more processors, cause, at least in part, an apparatus to receive a payment request via a radio frequency memory tag associated with a device. The apparatus is also caused to process and/or facilitate a processing of the payment request to determine whether the radio frequency memory tag includes a value that is sufficient to complete the payment request. The apparatus is further caused to, on a determination that the value is not sufficient, cause, at least in part, one or more actions that result in the device initiating a transfer of additional value to the radio frequency memory tag to complete the payment request.

According to another embodiment, an apparatus comprises means for receiving a payment request via a radio frequency memory tag associated with a device. The apparatus also comprises means for processing and/or facilitating a processing of the payment request to determine whether the radio frequency memory tag includes a value that is sufficient to complete the payment request. The apparatus further comprises means for, on a determination that the value is not sufficient, causing, at least in part, one or more actions that result in the device initiating a transfer of additional value to the radio frequency memory tag to complete the payment request.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing memory tag-based payment methods, according to one embodiment;

FIG. 2 is a diagram of the components of transaction management platform, according to one embodiment;

FIG. 3 is a flowchart of a process for providing memory tag-based payment methods, according to one embodiment;

FIG. 4 is a diagram of a transaction with a passive point of service, according to one embodiment;

FIGS. 5A and 5B are diagrams of alternative payment environments, according to various embodiments;

FIG. 6 is a diagram of device to device interaction, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for providing memory tag-based payment methods are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

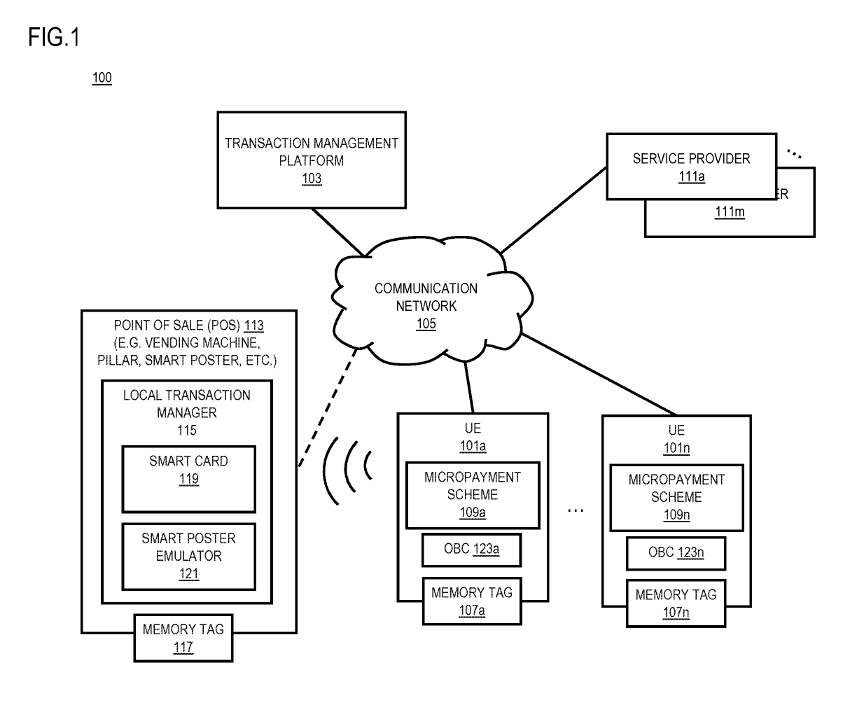

FIG. 1 is a diagram of a system capable of providing memory tag-based payment methods, according to one embodiment. The local Point of Service (POS) facilities such as vending machines, with the capability of providing various digitally supported services such as, for example, selling goods and accepting fund transfer from online accounts via mobile devices, or providing other services (e.g., tickets, reservations, etc.) are becoming popular. The POS facilities emulate smart posters to initiate fund transfer from alternative payment methods (e.g., PayPal, etc.) Smart Posters are signs, billboards, or any other form of advertising which will incorporate a passive (not-powered) Near Field Communication (NFC) Tag, from which a user can extract data by touching it with their NFC-enabled mobile device. The data could be, for example, a free ring-tone, a URL, or even the configuration for a local Wi-Fi hotspot.

There are widely agreed standards provided by regulatory authorities for the use of payment methods such as credit or debit cards. These standards include clear specification of transaction flows which may include, for example, steps such as card detection, application selection, cardholder verification, processing restrictions, online offline decision, etc.

In one embodiment, a mobile device may have an application identifier (AID) for each component or application associated with the authority, for example Europe MasterCard and Visa (EMV). The smart card or the RF memory tag associated with a mobile device can send a registered AID to the POS and an application or component of the authority verifies information such as transaction type, based on the transaction flow as defined by the authority. For example, EMV transaction flow may check and receive verification for mobile payment provider, mobile device, etc. Additionally, Payment System Environment (PSE), Domain Name System (DNS), and other information may also be verified.

In some embodiments, vending machines may function as Internet kiosks (always connected to the World Wide Web). However, in some other embodiments, the vending machines may function as local standalone kiosks (no need for constant connection to the World Wide Web). The standalone vending machines may provide items for sale such as, for example, content, bundled content, theatre tickets, event access, event tickets, etc. The standalone vending machines may also have capability for managing operations such as configuration, credentials, actions, etc.

In some embodiments, at the beginning of the day, the service providers may write the contents offered for sale and payment schemes into passive stickers (e.g. passive RF memory tags) at the POS or activate the content and payment methods previously written on the stickers. This will allow the stickers to be used for daily purchase of the services by users via their mobile devices. The stickers may also collect and store information such as payments (digital money), used content statistics (e.g. number of theater tickets purchased), etc.

In one embodiment, a vending machine can emulate a smart poster and initiate fund transfer for payment. For example, a parking facility may be equipped with a technology for payment of parking fee at a parking space via RFID tags associated with a mobile device by dialing a number, and entering the parking space ID and a length of time the person wishes to park. This technology has opened up very powerful resolutions to parking applications and permitting in authorized parking areas. Of all payment methods, this is the most innovative and flexible. This technology offers a convenient alternative payment method. All that is needed for implementation is instructional stickers prominently placed on single-space meters or posts. It can also be used to handle payments in a pay-and-display environment when needed.

However, situations may arise that a mobile device is equipped with a payment method which is not recognized by the POS applications (e.g. there is no application associated with the payment scheme at the POS). Therefore there is a need for alternative payment methods without existing micropayment application or any stored value within payment application.

To address this problem, a system 100 of FIG. 1 introduces the capability to provide passive payment methods. A passive POS provides payment and content delivery independent from content type, the payment system, etc. It is noted that transaction flow can include trusted passive POS (with no need for network connection), with passive RF memory tags when flow includes a trusted handover to the one time programmable (OTP) memory area of the mobile device, which is factory programmed, for that period and possibly with certain random time periods, to check trusted OTP presence during the entire transaction process.

In one embodiment, exchange of sensitive information such as credit card numbers can be avoided during the transaction, as backend (e.g. service provider at cloud environment, Amazon, etc.) can generate a hash-code from the sensitive information and provide the hash-code within the reach of a NFC capable sticker or loyalty card. In this embodiment, upon touching the loyalty card to the NFC reader, the reader reads the hash-code and adds it to a payment acknowledgement. The acknowledgment is then provided to the payment backend system for verification and approval.

In various embodiments, in order to prevent unintentional or intentional but unauthorized access to the hash-code, various approaches may be considered. For example, in one embodiment, the hash-code may not be read directly from the card, but instead the NFC reader can provide power to the card, upon getting close enough, and the card can write the hash-code to the NFC reader. In another embodiment, the hash-code can be combined with a network locking system identity such as, for example, Base Band 5 (BB5). The BB5 identity provides payment association to the mobile device and the loyalty card. In yet another embodiment, a permanent hash-code may generate a one time hash-code that will expire after being read once. And in yet another embodiment, multipurpose cards with additional recognitions and functions may be used that add more protection parameters for the management of transaction flow.

In one embodiment, the micropayment system and the NFC tag (e.g. RFID memory tag) can mechanically be passive stickers, for example associated with a smart poster. Additionally, the sales office (the POS) can be just a passive sticker at any pillar, ATM (vending machine), wall, attached to the sales item.

As shown in FIG. 1, the system 100 comprises user equipments (UE) 101a-101n having connectivity to the transaction management platform 103 via a communication network 105. The UEs 101a-101n also have connectivity to one or more POS 113 via NFC technology provided by memory tags 117 and 107a-107n. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 101a-101n are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 101a-101n can support any type of interface to the user (such as “wearable” circuitry, etc.).

A POS 113 may be capable of switching between active and passive modes whenever required by the transaction process. Additionally, the POS 113 is equipped with a local transaction manager 115 that manages transactions between the UEs 101a-101n and POS 113 during the passive mode of POS 113. The local transaction manager 115 may be factory programmed or being programmed and updated by the transaction management platform 103 during the active modes of the POS 113 or a combination thereof.

Furthermore, a UE 101a-101n may be equipped with a secured micropayment scheme 109a-109n which includes payment information of the associated UE 101a-101n such as, available funds, transaction authorization rules, etc.

In one embodiment, one or more service providers 111a-111m offer their services to the users of UEs 101a-101n via one or more POS 113. A user approaches the POS 113 and touches a specified location (e.g. sticker) on the POS 113 with their UE 101a-101n or holds the UE close to the POS 113, as it can be instructed in usage guides appearing on the POS display, on the UE display, or a combination thereof.

In one embodiment, the user of the UE 101a-101n may have already registered at the service provider 111a-111m. The registration process may include the specification of payment methods and the user may have received a PIN as an identifier. In this case, if the user does not insert any payment information the local transaction manager 115 sends, via the memory tag 117, a smart poster record that contains instructions on how to communicate with the service provider 111a-111m (e.g. a URL). Subsequently, the UE 101a-101n receives the smart poster via the memory tag 107a-107n and prompts the user to connect to service provider suggested by POS 113. Also, the micropayment scheme 109a-109n provides the user with payment options that the user can use with the specific service provider, based on the registration information stored in UE 101a-101n. Subsequently, the user follows the instructions, selects the desired payment option and keys in the PIN that the user has been assigned at the time of registration by the specific service provider 111a-111m. For example, payment may be made via a PayPal account.

In one embodiment, a programmable secure environment (e.g., On board Credentials with Open Provisioning (ObC)) 123a-123n functions as a smart card for providing funds. In one embodiment, ObC is an architecture for third party credentials developed using general-purpose secure payments. The ObC combines the flexibility of virtual credentials with the higher levels of protection due to the use of secure hardware. A distinguishing feature of the ObC architecture is that it is open, meaning that it allows anyone to design and deploy new credential algorithms to ObC capable devices without approval from the device manufacturer or any other third party. In this embodiment, if there are not enough funds available via the ObC 123a-123n for a purchase, the UE 101a-101n can interact with the service provider 111a-111m via the transaction management platform 103, and the transaction management platform 103 can activate a process to allow the user to arrange transfer funds between user accounts in order to top up the ObC 123a-123n for the micropayment scheme in use. The local transaction manager 115 may determine the micropayment scheme in use, the product and/or the value sold, etc.

In one embodiment, if a secure ObC environment with open provisioning exists, the service provider 111a-111m, which may be part of a cloud environment, may provision the micropayment scheme 109a-109n, ticketing algorithm, etc. to the UE 101a-101n in addition to secret codes and tokens representing the monetary value in the micropayment scheme. If algorithm provisioning is carried out, related application user interfaces (UIs) and other branding UIs may also be installed in the UE 101a-101n.

In lieu of ObC, any programmable secure environment, independently of issuer control in terms of provisioning (e.g. openness) can be used for provisioning and hosting the micropayment scheme. This may include white label smart cards (JavaCard technology) as well as a number of legacy security solutions such as, for example, ARM TrustZone, Trusted Computing Group/Trusted Platform Module (TCG/TPM) with late launch, Mobile Trusted Module (MTM), etc.

In one embodiment, if the memory tag 107a-107n does not support making connection to the service providers 111a-111m, the transaction may be temporarily suspended and forwarded to an alternative payment method. Subsequently, the suspended flow can be handed over to a mobile device trusted storage area (for example within the transaction management platform 103) which can initiate a trusted payment provider to check mobile device OTP (factory programmed one time programmable) memory area.

In one embodiment, a transaction can be entirely performed between the POS 113 on one hand and the micropayment scheme 109a-109n on the other hand, wherein the micropayment scheme 109a-109n is located in the secure environment of the UE 101a-101n.

In one embodiment, the exchange of sensitive information between the UE 101a-101n and the backend (e.g. service provider 111a-111m) can be avoided, as the backend 111a-111m can generates hash-code from sensitive information and provide the hash code via the transaction management platform 103 to the NFC capable sticker, loyalty card, or memory tag 117.

In one embodiment, the micropayment scheme 109a-109n may include data on successful transaction completion, key generation (e.g. POS ID), the paid amount, etc. This data can be transferred from the POS 113 to the micropayment scheme 109a-109n of UE 101a-101n by public key encryption. Additionally, the memory tag 107a-107n may contain a wealth of different tokens, tickets, etc. that are diversified by some secret algorithms based on the identity of UE 101a-101n. In this case, the POS 113 can be completely passive and the local transaction manager 115 of POS 113 may consist of an active NFC smart card 119 (with the micropayment scheme) and a smart poster emulator 121.

By way of example, the UEs 101a-101n, and the transaction management platform communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

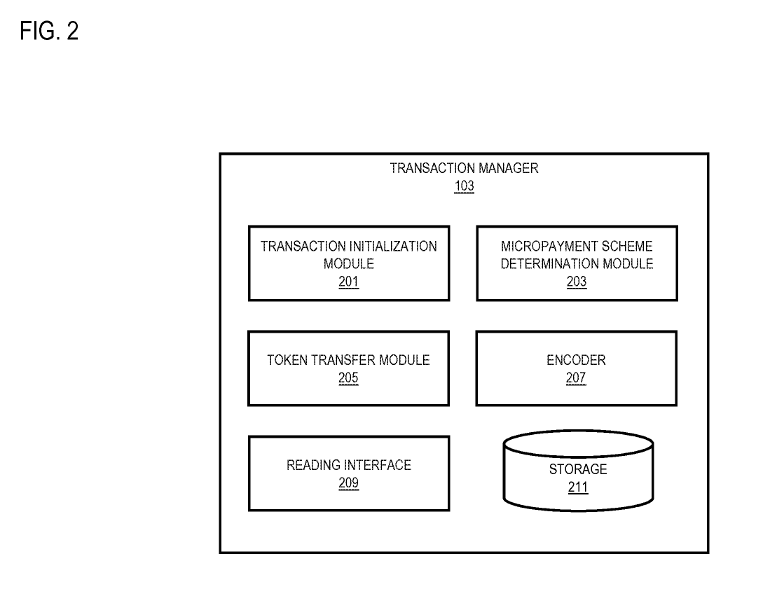

FIG. 2 is a diagram of the components of the transaction management platform, according to one embodiment. By way of example, the transaction management platform includes one or more components for providing memory tag-based payment methods. It is contemplated that the functions of these components may be combined in one or more components or performed by other components of equivalent functionality. In this embodiment, the transaction management platform includes a transaction initialization module 201, a micropayment scheme determination module 203, a token transfer module 205, an encoder 207, a reading interface 209, and a storage 211.

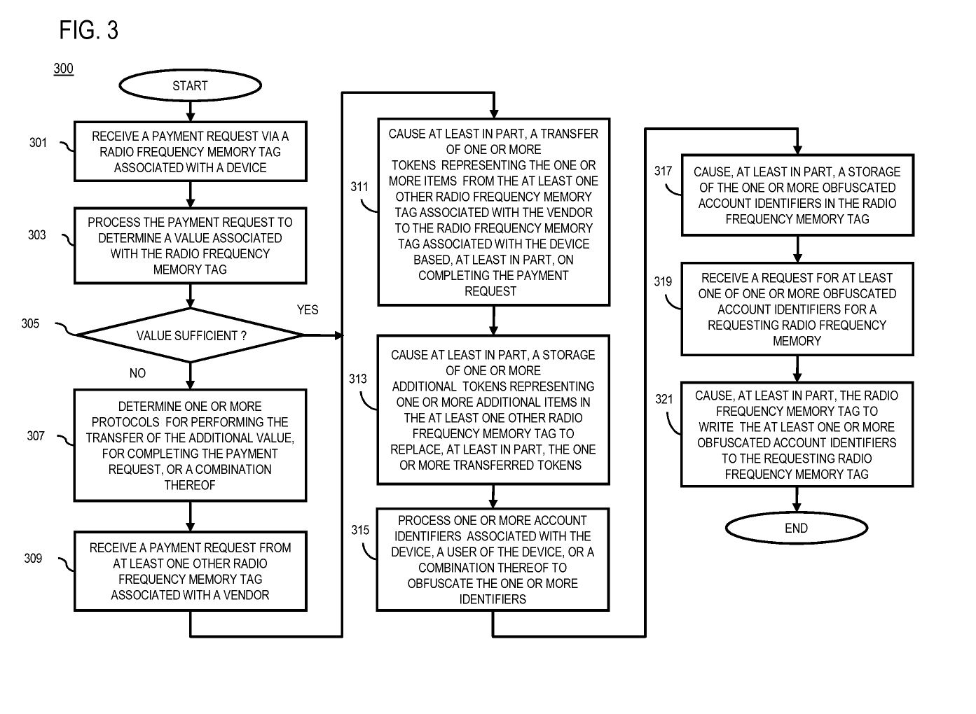

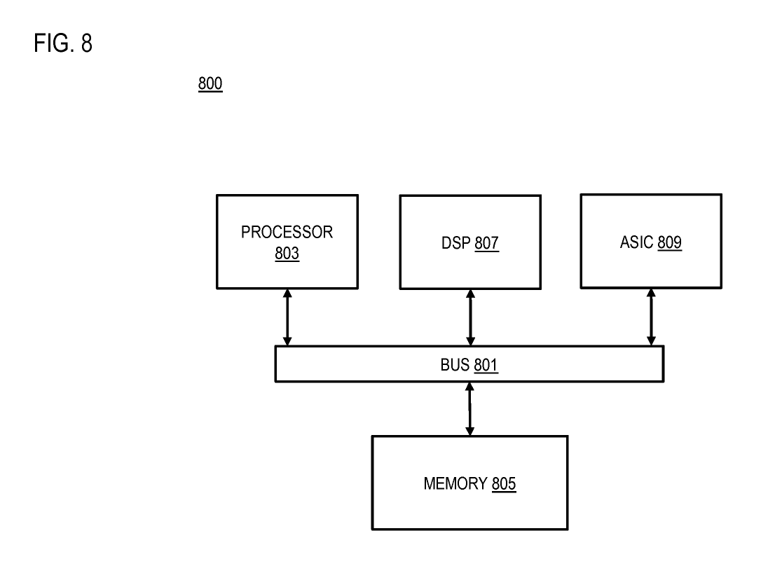

The components of FIG. 2 are described with reference to FIG. 3, wherein FIG. 3 is a flowchart of a process for providing memory tag-based payment methods, according to one embodiment. In one embodiment, the transaction management platform performs the process 300 and is implemented in, for instance, a chip set including a processor and a memory as shown in FIG. 8.

In one embodiment, per step 301 of process 300, the transaction initialization module 201 receives a payment request via a RF memory tag 107a-107n associated with a UE 101a-101n. The RF memory tag 107a-107n may function as a smart card so that funds can be added to and deducted from it. In one embodiment, a user of a UE 101a-101n may add value to the RF memory tag 107a-170n via an application provided on the UE 101a-101n. The application may draw funds from the user's bank account, credit card, etc. based on the settings provided by the user.

In one embodiment, per step 303, the transaction initialization module 201 processes and/or facilitates a processing of the payment request to determine whether the RF memory tag 107a-107n includes a value that is sufficient to complete the payment request. On a determination per step 305 that the value is not sufficient, per step 307 of process 300 the transaction initialization module 201 causes, at least in part, one or more actions that result in the UE 101a-101n initiating a transfer of additional value to the RF memory tag 107a-107n to complete the payment request.

In one embodiment, the actions caused by the transaction initialization module 201 may include activation of the micropayment scheme determination module 203. As shown per step 307 of FIG. 3, the micropayment scheme determination module 203 determines one or more protocols for performing the transfer of the additional value, for completing the payment request, or a combination thereof. The one or more protocols may include algorithms for how the payments are to be authenticated and made.

For example, the protocols may include user settings indicating the accounts to be used for fund withdrawal to be added to the RF memory tag 107a-107i, the passwords and authentication methods associated with one or more payment providers such as, for example, PayPal, Nokia Money, Bank accounts, etc.

In one embodiment, per step 309, the payment request may be received by the transaction initialization module 201 from at least one other RF memory tag 117 associated with a POS 113 (e.g., a vendor, vending machine, pillar, smart poster, etc.) wherein, the payment request is associated with at least one transaction related to one or more items available from the POS 113. For example, a use of the UE 101a-101n may be at a kiosk trying to by concert tickets via the RF memory tag 107a-107n associated with the UE 101a-101n. In this embodiment, the payment request may be sent to the transaction initialization module 201 from the RF memory tag 107a-107n associated with UE 101a-101n, from the RF memory tag 117 associated with the POS 113 or a combination thereof.

In one embodiment, per step 311 of FIG. 3, the token transfer module 205 causes, at least in part, a transfer of one or more tokens representing the one or more items from the at least one other RF memory tag 117 associated with the POS 113 to the RF memory tag 107a-107n associated with the UE 101a-101n based, at least in part, on completing the payment request. The tokens may include blocks representing the items in the memory tag 117, wherein the items are any products, services, etc. being purchased by the user of UE 101a-101n. In one embodiment, the token blocks may have a one to one correspondence with the items available for purchase. Subsequently, the user of UE 101a-101n can use the tokens stored on the RF memory tag 107a-107n of the UE 101a-101n to redeem the one or more purchased items, wherein redeeming may include, download, pick up from a physical store, or a combination thereof. In one embodiment, the one or more tokens can be encrypted blocks in the RF memory tag 117. Additionally, the transfer process of tokens from the RF memory tag 117 to the RF memory tags 107a-107n may include further encryption of the tokens to associate them with the specific user and/or a specific UE 101a-101n associated with the user, or a combination thereof.

In one embodiment, per step 313 of FIG. 3, the token transfer module 206 causes, at least in part, a storage of one or more additional tokens representing one or more additional items in the at least one other RF memory tag 117 to replace, at least in part, the one or more tokens that were transferred to the RF memory tag 107a-107n. For example, a notification system may be put in place at the local transaction manager 115 of the POS 113 to monitor the number of available tokens and alert the token transfer module 205 when the number of tokens at the POS 113 is lower than a predetermined lowest threshold. The tokens represent the number of items, service, etc. available for purchase at the POS 113. The transaction management platform 103 may monitor the token availability at multiple POS locations (not shown) by receiving reports from the local transaction manager 115 at every location and transfer the tokens additional tokens provided by the service providers 111a-111m to POS locations with low supply. The token transfer module 205 may also transfer tokens between the multiple POS locations, modify the thresholds, etc. based on the demand at every location.

In one embodiment, the RF memory tag 117 may be passive with no, or selective, network connection. For example, the POS 113 may be located in an area with no network availability. In such situation, the memory tag 117 may have already been uploaded with a repository of tokens associated with goods, items, services, etc. In this embodiment, the entire, or a subset of, the processes of the transaction management platform 103 can be performed and managed by the local transaction manager 115. For example, the POS 113 may be a passive sticker, for example a one time stickers for specific content. In this case the service provider 111a-111n may upload content (e.g. tokens) and payment schemes to the sticker 113 via the transaction management platform 103 at the beginning of day, or beforehand, and those stickers become valid when launched. Subsequently, during the passive period the local transaction manager 115 collects the information associated with the transactions that take place and at the end of the day the connection can be established and the transaction management platform 103 can collect the transaction information such as digital money, used content statistics, number of purchases, etc. and replenish the passive POS 113 for the next day, as previously described.

In one embodiment, per step 315 of FIG. 3, the encoder 207 processes and/or facilitates a processing of one or more account identifiers associated with the UE 101a-101n, a user of the UE 101a-101n, or a combination thereof to obfuscate the one or more identifiers. For example, the account identifier may be a password, a credit card number, a Bank account number, etc. The encoder 207 may read the one or more identifiers from the service provider 111a-111m, from a payment provider (not shown) such as for example PayPal, or a combination thereof. The encoder 207 may use different encryption methods, such as hash functions, for generating the obfuscated account identifier. Per step 317 of FIG. 3, the encoder 207 may cause, at least in part, storage of the one or more obfuscated account identifiers in the RF memory tag 107a-107n. In this case, at the time of purchase, there may be no need for the transaction management platform 103 to access the identifiers from the service provider or the payment provider, since at least a portion of the value can be provided via the one or more obfuscated account identifiers. This provides the capability of the purchase to be completed locally between the RF memory tag 107a-107n and the local transaction manager 115 with access to the identifier via the RF memory tag 117 from the RF memory tag 107a-107n, wherein the reduced exchange of sensitive identifiers over the network will reduce the risk of security breach or unauthorized access to the sensitive information.

In one embodiment, per step 319 of FIG. 3, the reading interface 209 receives a request for at least one of one or more obfuscated account identifiers from a requesting RF memory tag 117, for example during a transaction. The obfuscated account information, as previously described, was stored in RF memory tag 107a-107n by the encoder 207. In this embodiment the reading interface 209 causes, at least in part, the RF memory tag 107a-107n to write the at least one or more obfuscated account identifiers to the requesting RF memory tag 117. As previously explained, this will enhance information security, since the requesting memory tag 117 does not read the identifier, instead the memory tag 107a-107n with the identifier will proactively write to the requesting memory tag 117 in response to a request.

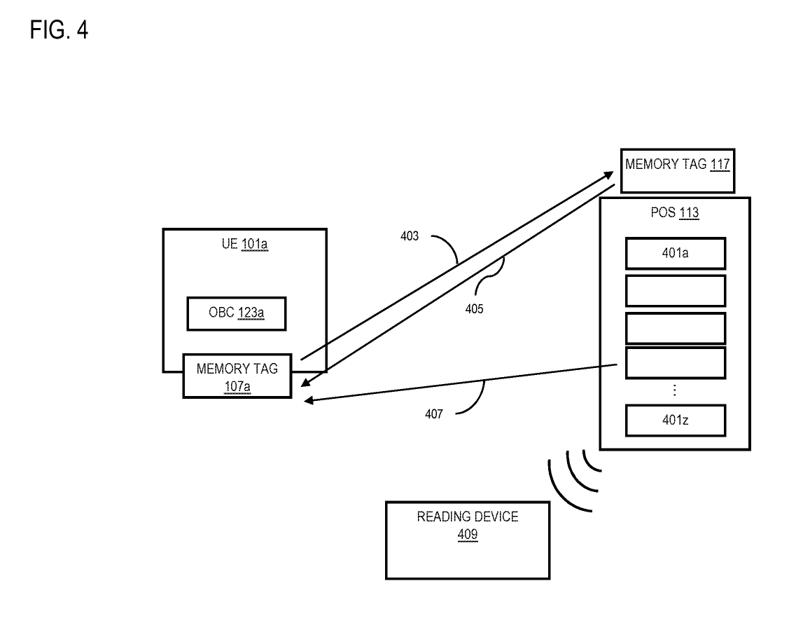

FIG. 4 is a diagram of a transaction with a passive point of service, according to one embodiment. In one embodiment, the user of UE 101a purchases an item from the POS 113. The items on sale are depicted as tokens 401a-401z in POS 113. The UE 101a makes a payment to the POS 113 via the memory tag 107a, shown by arrow 403. It is assumed in this example that the UE 101a is equipped with ObC 123a and the ObC 123a has sufficient found for the purchase. If the funds are insufficient, the UE 101a will communicate with a payment provider via the transaction management platform 103 (not shown) and top up the available ObC fund.

Upon the successful receipt of the payment by the POS 113, the POS 113 sends an ID and a key to the UE 101a, via arrow 405, wherein the ID is an identifier for a token 401a-401z for the item purchased by UE 101a and the key is an access key that will allow the UE 101a to claim the token with the received ID. The UE 101a can fetch the token from the POS 113 using the received key and ID, shown as arrow 407, and stores the token on memory tag 107a. Additionally, the UE 101 may decrypt the token using the key received from POS 113. Subsequently, the UE 101 can redeem the token when using the purchased service. For example, the user may use the token as a concert ticket at a concert venue equipped with a reader for the tokens which is capable of reading the token from a bearer (e.g. the memory tag 107a or a standalone memory tag).

In another embodiment, the POS 113 may provide a ticketing scheme for public transportation, that in most cases never use a server connection, except when the customer is out of money or does not have the right payment scheme. In one embodiment, the payment provided by UE 101a to POS 113 may also be in token form. By way of example, every morning a transport agency employee with a reading device 409 collects the accumulated micropayment tokens provided by UEs 101a-101n from a local storage (not shown) of the POS 113, the smart card 119, the smart poster emulator 121 or a combination thereof. The collected tokens can be used for clearing the payment at service provider 111a-111m via the transaction management platform 103.

Additionally the reading device 409 may provision to the POS 113 a number of new tokens, for example different tickets. In one embodiment, the ticket tokens when presented in decrypted form will be eligible for specific combinations of the ID provided by the POS 113 and time of the day (in case of concert tickets each ticket is uniquely identified, for example by seat numbers). During the purchase, the micropayment scheme 109a may collect the payment values from UE 101a to POS 113 and in return provide the decryption key for the appropriate ticket considering the provided ID and the current time of day. The UE 101a reads the appropriate ticket from the memory tag 107a and subsequently decrypts it. It is noted that all cryptographic operations take place in a secure environment and therefore not accessible by the user. It is also noted that that the micropayment scheme 109 is generic and not related to the contents of the tokens. Therefore, ticket validation (e.g. in the transport system) can be done with any suitable legacy mechanism and the payment will not be tied to the ticketing (except through the decryption key). Furthermore, no network connection is needed for most transactions, and if there is a need for network connection, the communication can be made via UE 101a.

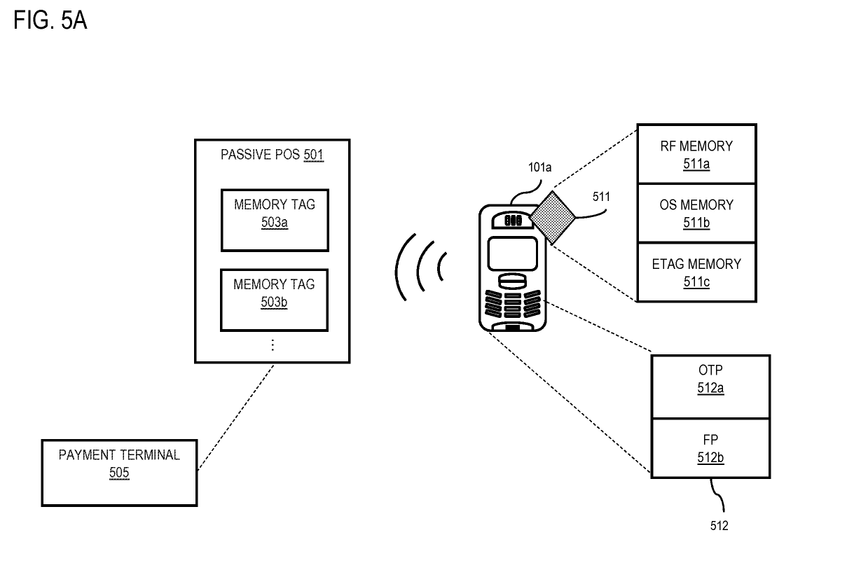

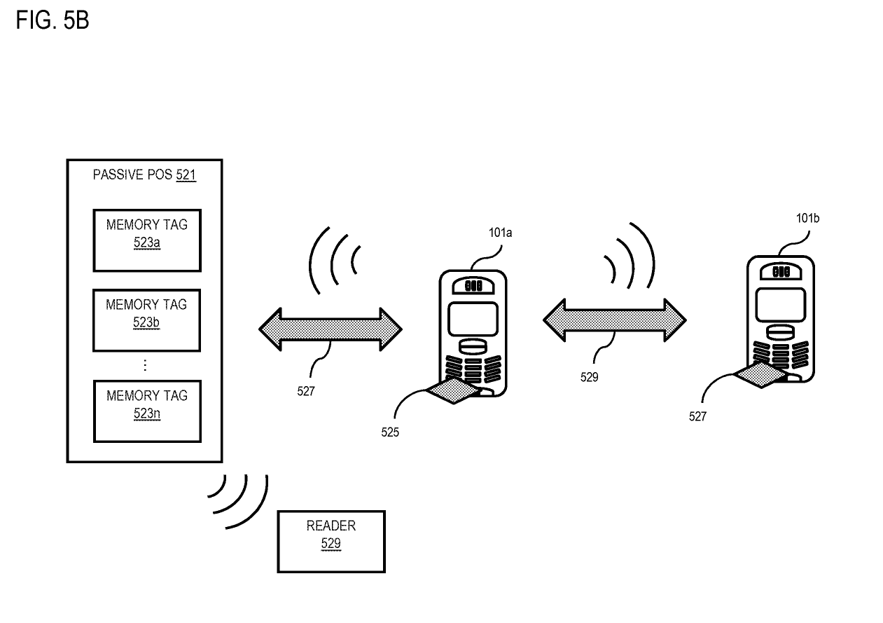

FIGS. 5A and 5B are diagrams of alternative payment environment, according to one embodiment. In one embodiment, as seen in FIG. 5A the UE 101a is located in the vicinity of a passive POS 501. The passive POS 501 may include multiple memory tags such as 503a and 503b with different capabilities offering a wide range of services. For example, memory tag 503a may be used as a tag for collecting payment information associated with trusted credit payments while memory tag 503b may be a co-branded memory tag. The co-branded memory tag 503b may provide content, payment, or a combination thereof. For example, if the payment terminal 505 is a gas station the memory tag 503b may provide payment capability to the user of UE 101a and in addition to payment, provide fuel tokens to be used at the pump. A co-branded passive memory tag 503b can be initiated at the factory, periodically during the service (daily, weekly, monthly, etc.) or a combination thereof. The factory setup may upload the memory tag with applications required for communication with consumer devices UEs 101a-101n, service providers 111a-111m, payment providers (PayPal, Amazon, Nokia Money, Bank accounts, etc.) or a combination thereof. The periodical initializations may include transfer of accumulated payments from the memory tags 503a and 503b to the service providers 111a-111m via the payment providers, replenishing the memory tag 503b with new content (e.g. tokens), etc. For example, at the end of the day the gas station operator may connect the passive POS 501 to the payment terminal 505 wherein the payment terminal 505 can collectively validate and authorize the gas bills accumulated in the memory tags 503a and 503b during the day. The payment terminal 505 can also clear the used tokens from the memory tag 503b and refill the memory tag with new tokens for the next day.

In one embodiment, the payment terminal 505 may also change the setup of the passive POS 501 if needed. For example, new payment providers or service providers may be added to the list of provided services or acceptable payment methods, payment providers and/or service providers may be removed, payment provider and/or service provider information may be updated, policies, rules and regulations associated with the transactions may be updated, etc. Instructions associated with the updates can be provided by the transaction management platform 103 to the payment station 505 via the communication network 105. However, the passive POS 501 will remain passive during the operation period, for example during a normal working day at a gas station.

In one embodiment, if during the passive period of the passive POS 501, situations arise that network communication is needed for the problem to be resolved, the communication can be performed via the UE 101a. A UE 101a may be equipped with various types of memory such as, for example, one or more active memory tags 511, which may include various memory areas within the same tag, shown as a memory stack of RF memory 511a, OS memory 511b, E-tag memory 511c, etc.

Additionally, the UE 101a may include various types of internal memory stacks 512 which may include memory areas such as for example One Time Programmable memory (OTP) 512a, Factory Programmed memory (FP) 512b, etc. It is noted that the identification information associated with the UE 101a may have been stored by the manufacturer in the FP 512b, wherein this information is not accessible by the user. In one embodiment, if any issues arise during the transaction between the UE 101a and the passive POS 501, an application of the UE 101a may be activated and as a result the transaction management platform 103 may communicate with the UE 101a after verifying the identity of the UE 101a based on the content of FP 512b. The UE 101a may also send information about the identity and location of the passive POS 501 and the type of error occurred to the transaction management platform 103 so that the transaction management platform 103 can resolve the issue. This feature is especially beneficial in areas where limited network communication is available because as explained, the POS 501 can remain passive throughout the entire transaction.

FIG. 5B is a diagram showing a process of purchasing and redeeming a service, according to one embodiment. In one embodiment, as seen in FIG. 5B, the UE 101a is located in the vicinity of a passive POS 521. The passive POS 521 may be, for example a smart poster and include multiple memory tags (e.g. stickers) 523a-523n with different capabilities offering a wide range of services. For example, memory tag 523a may be used as a tag for collecting payment information associated with trusted credit payments.

In one embodiment, the user of UE 101a purchases a service (for example a theater ticket) from the smart poster 521 and pays the service fees by memory tag 525 via the memory tag 523a. The payment may include a key for decryption of the identification content accompanying the payment. The smart poster 521 reads the payment from the memory tag 523a and processes the payment. In return, the smart poster 521 writes the ticket content via a memory tag 523a-523n writes the ticket content to the memory tag 525 of UE 101a (shown as arrow 527). The ticket content may include ticket information such as show date and time, seat numbers, etc. The ticket content may also include information about the smart poster the ticket was purchased from, identification information of the UE 101a in order to associate the ticket to the specific user of UE 101a, etc.

In one embodiment, the UE 101a reads the ticket content from the memory tag 525 and stores the content in the memory of the UE 101a. Alternatively, the tag 525 may write the ticket content to the memory of UE 101a for further use. It is noted that the ticket content may be encrypted for security and privacy purposes.

In one embodiment, the smart poster 521 may be equipped with a list of available seats and mark the purchased seats in the list as “sold” so that they do not appear to next customers as available seats.

In one embodiment, at the time when the user of UE 101a is going to use the purchased service (tickets), the user may select a certain menu item on the UE 101a to access the tickets. The access to purchased services may require the user to enter a password or other information related to the tickets to prevent unauthorized access to the services.

In one embodiment, the user of UE 101a uses the UE 101a to claim the tickets at the operation counter at the theater. The user may do so, for example, by approaching an organizer mobile reader 101b. The UE 101a may copy the ticket information to memory tag 527 of UE 101b (shown as arrow 529) and UE 101b in return send updated ticket information to tag 525 of UE 101a. Alternatively, the UE 101a may copy the ticket information back to tag 525 and the UE 101b read the ticket information directly from tag 525.

In one embodiment, at the time of fund collection, funds or fund representing tokens provided by the UE 101a to the smart poster 521 are read away by authorized mobile reader(s) 529. The reader 529 may also reset the fund account on the smart poster 521 and initialize (refill) the poster with contents for further services.

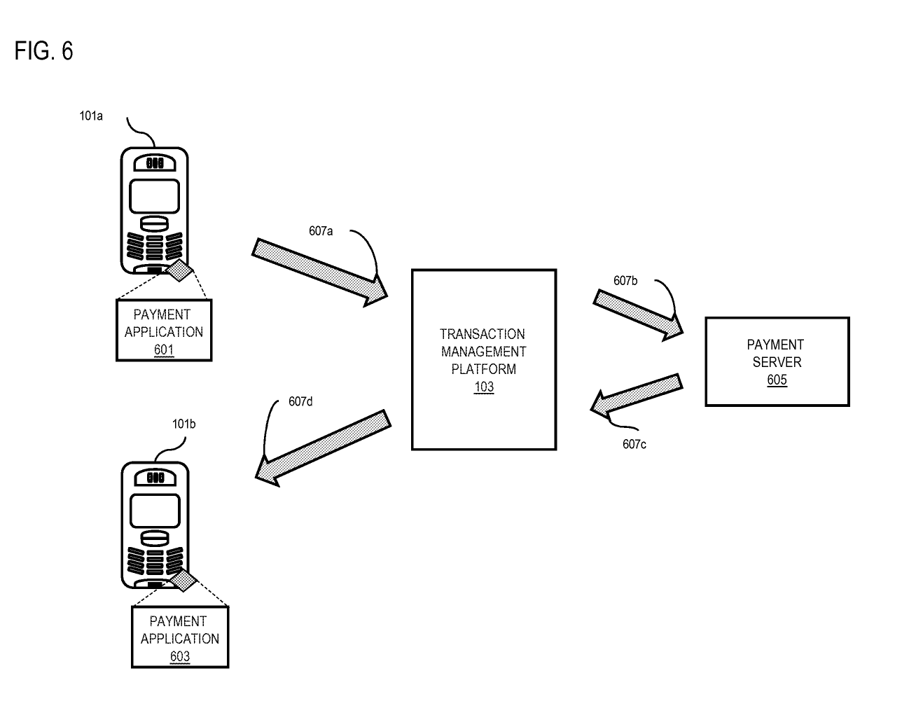

FIG. 6 is a diagram of device to device interaction, according to one embodiment. In one embodiment, the user of UE 101a may want to directly perform a transaction via UE 101a with UE 101b. For example, the user may want to pay a debt of $100 to the user of UE 101b via an On board Credential with Open Provisioning (ObC), for example a smart card, associated with UE 101a. In this embodiment, the payment application 601 of the UE 101a may communicate with the transaction management platform 103, shown as arrow 607a, sending information about the desired transaction including the other party's (UE 101b) identification. The payment application 601 may be downloaded into the UE 101a, stored in a RF memory tag associated with UE 101a, or a combination thereof. The transaction management platform 103 may verify the identity of UE 101a (for example by access to the FP or OTP of UE 101a, requesting the user, via the payment application 601, to enter a password, etc.) prior to initiating a transaction. The transaction management platform 103 may also verify the identity of UE 101b, via a payment application 603, search for data and statistics on previous transactions between UE 101a and UE 101b, in local UE storages, in storage 211, etc. Upon approval of the sender and receiver identities the transaction management platform 103 may initiate a transaction by sending the transaction information to a payment server 605, shown as arrow 607b. The payment server 605 may be selected based on a selection by the user of UE 101a, a default set up on UE 101a, a set up by the payment application 601, a detection by the transaction management platform 103, or a combination thereof.

In one embodiment, the payment server 605 (e.g. PayPal, Bank, etc.) may verify the identity of sender and receiver from the point of view of the transaction, such as account verification, available funds, etc. In one embodiment, if the user of UE 101a is using an ObC and there is not sufficient fund for the requested payment, the payment server 605 can transfer funds from user account to the ObC after acquiring user's permission. Upon the verification of accounts for both parties UE 101a and UE 101b, the payment server 605 transfers funds from the account associated with UE 101a to the account associated to UE 101b and informs the transaction management platform 103 about the approval and transfer, wherein the transaction management platform 103 sends information about the successful transaction to both UEs 101a and 101b.

In one embodiment, if both UEs 101a and 101b are using ObC smart cards and the ObC of UE 101a has sufficient funds for the payment available, the transfer does not need to go through the payment server 605. In this embodiment, following the verification of identities of the two parties, the transaction management platform 103 may communicate with the payment applications 601 and 603 so that the payment amount is subtracted from the ObC of UE 101a and added to the ObC of UE 101b.

In one embodiment, a group of users (e.g. family members) can generate a common pool of funds so that all the group members can repeatedly add or subtract payment to and from the pool. In one embodiment, a member of the group as administrator can define the level of authority and access to the pool for other members of the group.

In one embodiment, the UEs of group members can be registered in a cloud environment with digital signatures and the digital signatures can be used as transaction identifiers for the members of the group.

In one embodiment, each user can define restrictions to be associated with their accounts to for example limit their consent for allowed transactions, information sharing with other users and/or with various, (payment related or non-payment related, applications, etc.

The processes described herein for providing memory tag-based payment methods may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

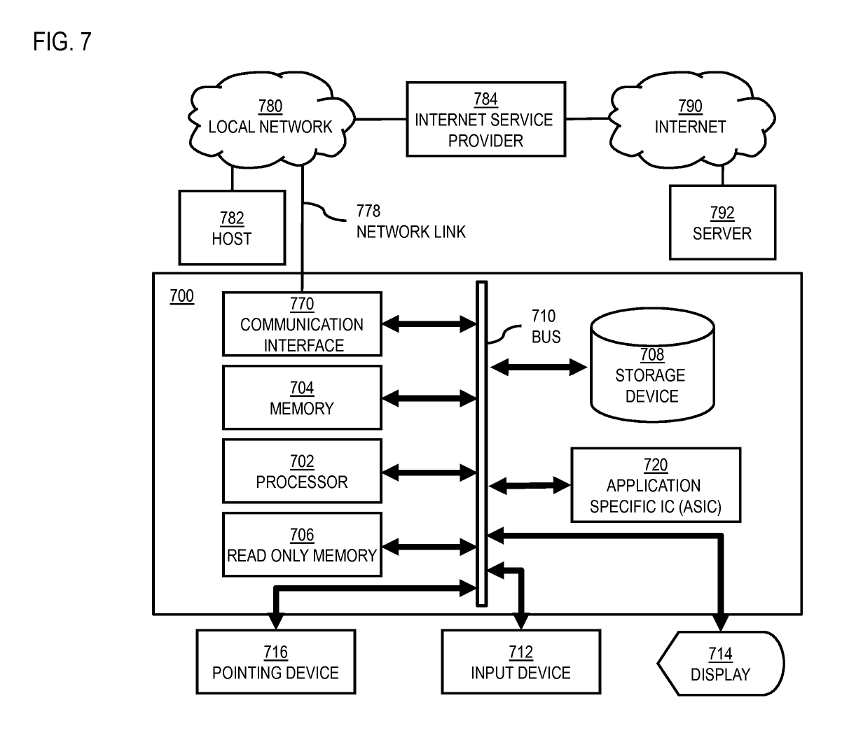

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to provide passive payment methods as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of providing memory tag-based payment methods.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to providing memory tag-based payment methods. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for providing memory tag-based payment methods. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for providing memory tag-based payment methods, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for providing memory tag-based payment methods to the UEs 101a-101n.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to provide passive payment methods as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of providing memory tag-based payment methods.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide passive payment methods. The memory 805 also stores the data associated with or generated by the execution of the inventive steps.

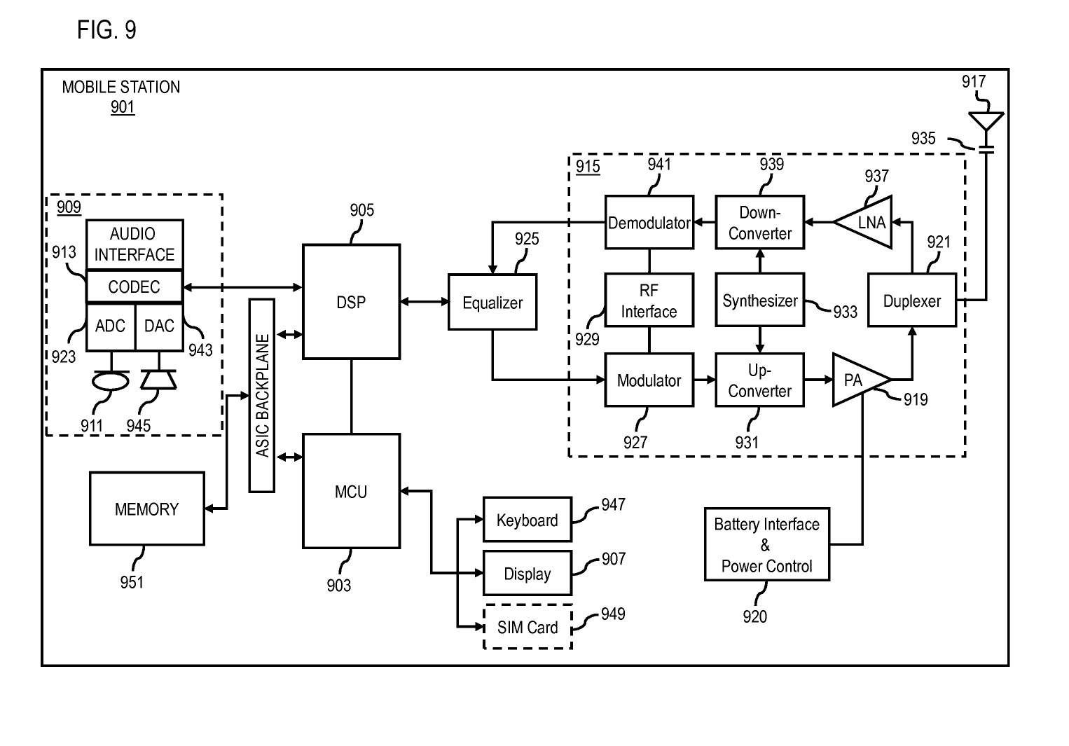

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of providing memory tag-based payment methods. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of providing memory tag-based payment methods. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to provide passive payment methods. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a payment request via a radio frequency memory tag associated with a device;
a processing of the payment request to determine whether the radio frequency memory tag includes a value that is sufficient to complete the payment request; and
on a determination that the value is not sufficient, an initiation of one or more actions that result in the device initiating a transfer of additional value to the radio frequency memory tag to complete the payment request.

2. A method of claim 1, wherein the (1) data and/or (2) information and/or (3) at least one signal are further based, at least in part, on the following:
one or more protocols for performing the transfer of the additional value, for completing the payment request, or a combination thereof,
wherein the one or more protocols are associated with one or more payment providers.

3. A method of claim 1, wherein the payment request is received from at least one other radio frequency memory tag associated with a vendor, and wherein the payment request is associated with at least one transaction related to one or more items available from the vendor.

4. A method of claim 3, wherein the (1) data and/or (2) information and/or (3) at least one signal are further based, at least in part, on the following:
a transfer of one or more tokens representing the one or more items from the at least one other radio frequency memory tag associated with the vendor to the radio frequency memory tag associated with the device based, at least in part, on completing the payment request.

5. A method of claim 3, wherein the (1) data and/or (2) information and/or (3) at least one signal are further based, at least in part, on the following:
a storage of one or more additional tokens representing one or more additional items in the at least one other radio frequency memory tag to replace, at least in part, the one or more transferred tokens.

6. A method of claim 3, wherein the at least one other radio frequency memory tag is passive.

7. A method of claim 1, wherein the (1) data and/or (2) information and/or (3) at least one signal are further based, at least in part, on the following:
a processing of one or more account identifiers associated with the device, a user of the device, or a combination thereof to obfuscate the one or more identifiers; and
a storage of the one or more obfuscated account identifiers in the radio frequency memory tag,
wherein at least a portion of the value is provided via the one or more obfuscated account identifiers.

8. A method of claim 7, wherein the (1) data and/or (2) information and/or (3) at least one signal are further based, at least in part, on the following:
a processing of the one or more account identifiers using at least one hash function to generate the one or more obfuscated account identifiers.

9. A method of claim 8, wherein the (1) data and/or (2) information and/or (3) at least one signal are further based, at least in part, on the following:
a request for at least one of one or more obfuscated account identifiers from a requesting radio frequency memory tag; and
at least one determination to cause, at least in part, the radio frequency memory tag to write the at least one or more obfuscated account identifiers to the requesting radio frequency memory tag.

10. A method of claim 1, wherein the processing of the payment request is performed according to an on board credentials infrastructure associated with the device.

11. An apparatus comprising:
at least one processor; and
at least one memory including computer program code for one or more programs,
the at least one memory and the computer program code configured to, with the at least one processor, cause the apparatus to perform at least the following,
receive a payment request via a radio frequency memory tag associated with a device;
process and/or facilitate a processing of the payment request to determine whether the radio frequency memory tag includes a value that is sufficient to complete the payment request; and
on a determination that the value is not sufficient, cause, at least in part, one or more actions that result in the device initiating a transfer of additional value to the radio frequency memory tag to complete the payment request.

12. An apparatus of claim 11, wherein the apparatus is further caused to:
determine one or more protocols for performing the transfer of the additional value, for completing the payment request, or a combination thereof,
wherein the one or more protocols are associated with one or more payment providers.

13. An apparatus of claim 11, wherein the payment request is received from at least one other radio frequency memory tag associated with a vendor, and wherein the payment request is associated with at least one transaction related to one or more items available from the vendor.

14. An apparatus of claim 13, wherein the apparatus is further caused to:
cause, at least in part, a transfer of one or more tokens representing the one or more items from the at least one other radio frequency memory tag associated with the vendor to the radio frequency memory tag associated with the device based, at least in part, on completing the payment request.

15. An apparatus of claim 13, wherein the apparatus is further caused to:
cause, at least in part, a storage of one or more additional tokens representing one or more additional items in the at least one other radio frequency memory tag to replace, at least in part, the one or more transferred tokens.

16. An apparatus of claim 13, wherein the at least one other radio frequency memory tag is passive.

17. An apparatus of claim 11, wherein the apparatus is further caused to:
process and/or facilitate a processing of one or more account identifiers associated with the device, a user of the device, or a combination thereof to obfuscate the one or more identifiers; and
cause, at least in part, a storage of the one or more obfuscated account identifiers in the radio frequency memory tag,
wherein at least a portion of the value is provided via the one or more obfuscated account identifiers.

18. An apparatus of claim 17, wherein the apparatus is further caused to:
process and/or facilitate a processing of the one or more account identifiers using at least one hash function to generate the one or more obfuscated account identifiers.

19. An apparatus of claim 18, wherein the apparatus is further caused to:
receive a request for at least one of one or more obfuscated account identifiers from a requesting radio frequency memory tag; and
cause, at least in part, the radio frequency memory tag to write the at least one or more obfuscated account identifiers to the requesting radio frequency memory tag.

20. An apparatus of claim 11, wherein the processing of the payment request is performed according to an on board credentials infrastructure associated with the device.
